(19) United States
(12) Patent Application Publication
(10) Pub. No.: US 2020/0202208 A1
(43) Pub. Date: Jun. 25, 2020

(54) AUTOMATIC ANNOTATION AND GENERATION OF DATA FOR SUPERVISED MACHINE LEARNING IN VEHICLE ADVANCED DRIVER ASSISTANCE SYSTEMS

(71) Applicants: Dalong Li, Troy, MI (US); Adams Timmons, Royal Oak, MI (US)

(72) Inventors: Dalong Li, Troy, MI (US); Adams Timmons, Royal Oak, MI (US)

(21) Appl. No.: 16/225,042

(22) Filed: Dec. 19, 2018

(51) Int. Cl. G06N 3/08; G06N 20/00; G01S 7/48

(52) U.S. Cl. CPC G06N 3/08; G01S 7/4808; G06N 20/00

(57) ABSTRACT

Techniques for automatically labeling and generating sensor data includes obtaining first sensor data corresponding to a controlled environment containing at least one known object that has known spatial characteristics, linking the first sensor data with the at least one known object to obtain automatically labeled sensor data that associates at least a portion of the first sensor data with the spatial characteristics of the at least one known object. The techniques further include obtaining second sensor data corresponding to an uncontrolled environment containing at least one unknown object, which is detected by utilizing a machine learning model. Portions of the second sensor data corresponding to the at least one unknown object are extracted to obtain background cloud data, and the automatically labeled sensor data is inserted into the background cloud data to obtain system generated labeled sensor data for training the machine learning model.

### FIELD

The present application generally relates to vehicle advanced driver assistance systems (ADAS) and, more particularly, to techniques for automatically annotating and generating training data for use in supervised machine learning.

### BACKGROUND

Some vehicle advanced driver assistance systems (ADAS) utilize light detection and ranging (LIDAR) systems to capture information. LIDAR systems emit laser light pulses and capture pulses that are reflected back by surrounding objects. By analyzing the return times and wavelengths of the reflected pulses, three-dimensional (3D) LIDAR point clouds are obtained. Each point cloud comprises a plurality of reflected pulses in a 3D (Wyk) coordinate system). These point clouds could be used to detect objects (other vehicles, pedestrians, traffic signs, etc.). In order to distinguish between different types of objects, extensively trained deep neural networks (DNNs) are typically used. Such DNNs may require a substantial amount of labeled training data in order to be trained to perform as intended. Such labeled training data (e.g., manually annotated point clouds) is typically generated by a manual annotation process in which a human actively annotates sensor data. This manual annotation process can be time consuming and costly. Further, for uncommon or rarely occurring events (which can sometimes be referred to as “corner cases”), the relatively small amount of data corresponding to such events in the large amount of training data may result in the machine learning model being trained to ignore or not effectively recognize such corner cases without additional training or tuning. Accordingly, although the existing process for acquiring labeled training data may permit vehicle ADAS to work well for their intended purpose, there remains a need for improvement in the relevant art.

### SUMMARY

According to one example aspect of the invention, a computer-implemented method of training a machine learning model is disclosed. In one example implementation, the method includes obtaining, at a computing device having one or more processors, first sensor data corresponding to a controlled environment containing at least one known object that has known spatial characteristics. The first sensor data is linked, at the computing device, with the at least one known object to obtain automatically labeled sensor data for the at least one known object. The automatically labeled sensor data associates at least a portion of the first sensor data with the spatial characteristics of the at least one known object. The method further includes obtaining, at the computing device, second sensor data corresponding to an uncontrolled environment containing at least one unknown object. The at least one unknown object is detected, at the computing device, in the uncontrolled environment based on the second sensor data by utilizing a machine learning model that is trained to detect objects based on sensor data. A portion of the second sensor data corresponding to the at least one unknown object is extracted from the second sensor data to obtain background cloud data. The method includes inserting, at the computing device, the automatically labeled sensor data into the background cloud data to obtain system generated labeled sensor data. The system generated labeled sensor data corresponds to the uncontrolled environment with the at least one unknown object removed and at least one known object from the controlled environment inserted. The method also includes training, at the computing device, the machine learning model based on the system generated labeled sensor data.

In some implementations, the first sensor data corresponds to data obtained from a light detection and ranging (LIDAR) system. Further, the known spatial characteristics of the at least one known object can be obtained from additional sensors.

According to some aspects of the present application, the method can further comprise detecting, at the computing device, free space within the background cloud data, wherein the free space corresponds to one or more locations in which the at least one known object can be present in the uncontrolled environment. A deep neural network (DNN) can be utilized to detect the free space. Further, the at least one known object from the controlled environment can be inserted in the detected free space.

In some aspects, the method further comprises validating, at the computing device, the machine learning model based on the automatically labeled sensor data.

In some implementations, training the machine model is further based on the automatically labeled sensor data.

Additionally or alternatively, in some aspects linking the first sensor data with the at least one known object to obtain automatically labeled sensor data for the at least one known object includes editing the first sensor data to determine modified first sensor data corresponding to a change in at least one of a position, orientation, and size of the known object. In such implementations, the automatically labeled sensor data for the at least one known object is based on the modified first sensor data.

According to another example aspect of the invention, a computing device for training a machine learning model is disclosed. The computing device includes one or more processors and a non-transitory computer-readable storage medium having a plurality of instructions stored thereon, which, when executed by the one or more processors, cause the one or more processors to perform operations. The operations include obtaining first sensor data corresponding to a controlled environment containing at least one known object that has known spatial characteristics. The first sensor data is linked with the at least one known object to obtain automatically labeled sensor data for the at least one known object. The automatically labeled sensor data associates at least a portion of the first sensor data with the spatial characteristics of the at least one known object. The operations further include obtaining second sensor data corresponding to an uncontrolled environment containing at least one unknown object. The at least one unknown object is detected in the uncontrolled environment based on the second sensor data by utilizing a machine learning model that is trained to detect objects based on sensor data. A portion of the second sensor data corresponding to the at least one unknown object is extracted from the second sensor data to obtain background cloud data. The operations also include inserting the automatically labeled sensor data into the background cloud data to obtain system generated labeled sensor data. The system generated labeled sensor data corresponds to the uncontrolled environment with the at least one unknown object removed and at least one known object from the controlled environment inserted. The operations further include training the machine learning model based on the system generated labeled sensor data.

In some implementations, the first sensor data corresponds to data obtained from a light detection and ranging (LIDAR) system. Further, the known spatial characteristics of the at least one known object can be obtained from additional sensors.

According to some aspects of the present application, the operations can further comprise detecting free space within the background cloud data, wherein the free space corresponds to one or more locations in which the at least one known object can be present in the uncontrolled environment. A deep neural network (DNN) can be utilized to detect the free space. Further, the at least one known object from the controlled environment can be inserted in the detected free space.

In some aspects, the operations further comprise validating the machine learning model based on the automatically labeled sensor data.

In some implementations, training the machine model is further based on the automatically labeled sensor data.

Additionally or alternatively, in some aspects linking the first sensor data with the at least one known object to obtain automatically labeled sensor data for the at least one known object includes editing the first sensor data to determine modified first sensor data corresponding to a change in at least one of a position, orientation, and size of the known object. In such implementations, the automatically labeled sensor data for the at least one known object is based on the modified first sensor data

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a functional block diagram of an example vehicle having an advanced driver assistance system (ADAS) with an optional light detection and ranging (LIDAR) system according to some implementations of the present disclosure;

FIG. 2 is a functional block diagram of an example automatic data annotation architecture according to some implementations of the present disclosure; and

FIG. 3 is a flow diagram of an example method for generating system generated labeled sensor data according to some implementations of the present disclosure.

### DETAILED DESCRIPTION

As discussed above, there exists a need for improvement in automated driver assistance systems (ADAS) and the training techniques thereof. It will be appreciated that the term “ADAS” as used herein includes driver assistance systems (lane keeping, adaptive cruise control, etc.) as well as partially and fully autonomous driving systems. Such ADAS may or may not utilize light detection and ranging (LIDAR) for object detection. A conventional ADAS with a LIDAR system for object detection utilizes a deep neural network (DNN) trained by machine learning with “labeled” training data. The typical process for obtaining such labeled training data is manual annotation in which a human actively annotates sensor data, e.g., by identifying objects and their associated spatial characteristics. This manual annotation process can require a substantial amount of resources and can be time consuming and costly. Accordingly, techniques for automatically labeling (annotating) sensor data and generating new (simulated) labeled sensor data are presented. These techniques involve obtaining sensor data corresponding to known object(s) in a controlled environment and utilizing the known aspects (“ground truth”) of such objects to automatically annotate or label the obtained sensor data.

Further, the techniques can include inserting the labeled sensor data of known objects into later obtained sensor data corresponding to an uncontrolled environment to generate “new” labeled sensor data for training. For example only, sensor data may be acquired from an unknown environment and a machine learning model can be used to detect objects in such sensor data. These unknown objects (the data corresponding to such objects) are removed from the sensor data to obtain background cloud data. The previously acquired labeled sensor data corresponding to the known objects is then inserted into the background cloud data, e.g., by determining the free space within the background cloud data. Free space refers to one or more locations in which known objects can be present in the uncontrolled environment, for example, open lanes or roads in which a car can be present. The background cloud data with the labeled sensor data corresponding to the known objects inserted therein (system generated labeled sensor data) is used to train/improve/validate the machine learning model. In this manner, large amounts of generated (or simulated) training data can be obtained and utilized to train the machine learning model, thereby improving the performance of the ADAS and the machine learning model. Such improved performance may be particularly useful for uncommon or rarely occurring events (“corner cases”).

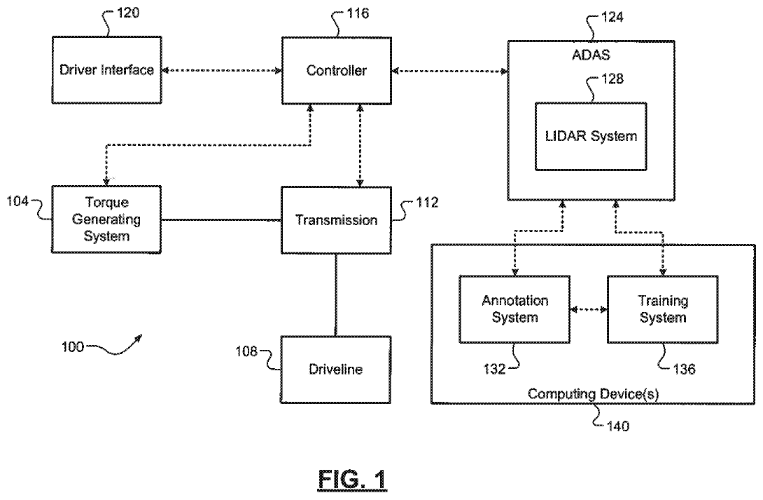

Referring now to FIG. 1, a functional block diagram of an example vehicle 100 is illustrated. The vehicle 100 comprises a torque generating system 104 (an engine, an electric motor, combinations thereof, etc.) that generates drive torque that is transferred to a driveline 108 via a transmission 112. A controller 116 controls operation of the torque generating system 104, such as to generate a desired drive torque based on a driver input via a driver interface 120 (a touch display, an accelerator pedal, combinations thereof, etc.). The vehicle 100 further comprises an ADAS 124 having a LIDAR system 128. While the ADAS 124 is illustrated as being separate from the controller 116, it will be appreciated that the ADAS 124 could be incorporated as part of the controller 116, or the ADAS 124 could have its own separate controller.

The LIDAR system 128 emits laser light pulses and captures reflected laser light pulses (from other vehicles, structures, traffic signs, etc.) that collectively form captured 3D LIDAR point cloud data. It should be appreciated that the ADAS 124 could include other suitable systems, such as, but not limited to, a radio detection and ranging (RADIO) system, a camera/lens system, an inertial motion unit (IMU) system, a real-time kinematic (RTK) system, and a Differential Global Positioning System (“DGPS”).

The ADAS 124 communicates with an annotation system 132 and a training system 136 that are separate from the vehicle 100. As more fully described below, the annotation system 132 receives data from one or more sensors of a vehicle (such as vehicle 100) in a controlled environment and automatically links the received data with known information of a known object to obtain automatically labeled sensor data. The automatically labeled sensor data is then used by the training system 136 to train machine learning models for the ADAS 124, such as DNNs, to assist with object detection, autonomous driving, etc. While the annotation system 132 and training system 136 are described as separate devices, it should be appreciated that these systems could instead be implemented by one or more computing device(s) 140 working separately or in conjunction to perform the tasks described herein.

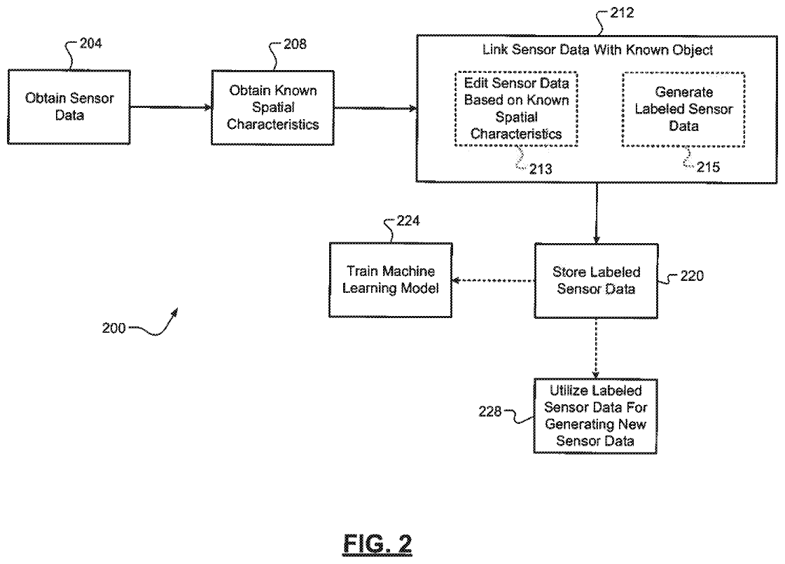

Referring now to FIG. 2, a functional block diagram of an example automatic data annotation architecture 200 is illustrated. As mentioned above, it will be appreciated that this architecture 200 could be implemented primarily by the annotation system 132, but portions of the techniques described herein could be implemented by the training system 136, the ADAS 124, and/or the controller 116 of the vehicle 100. At 204, sensor data is obtained (e.g., after being captured using the LIDAR system 128). The obtained sensor data corresponds to a controlled environment that contains at least one known object. For the case in which the sensor data is captured by the LIDAR system 128, the sensor data could include, for example, analyzing return times and wavelengths of laser light pulses transmitted from and reflected back to the LIDAR system 128. It should be appreciated that the sensor data could also or alternatively be obtained from other types of sensors.

At 208, known spatial characteristics of the known object in the controlled environment are obtained. For example only, the controlled environment may correspond to an automotive proving grounds in which vehicles (such as vehicle 100) can be tested, validated, etc. and in which known objects are present. Examples of known objects include but are not limited to other vehicles, trees and/or other natural objects, mock pedestrians, and signs and/or other manmade objects. For stationary known objects such as trees and signs, the corresponding known spatial characteristics are stored and unchanging. For non-stationary known objects (e.g., other vehicles), each known object will include additional sensors (DGPS, accelerometer, speedometer, etc.) that provide data sufficient to identify a location, orientation, etc. of the known object. The known spatial characteristics of these known objects can be obtained from the additional sensors. In this manner, the known aspects or “ground truth” of such known objects can be determined.

The sensor data obtained from 204 is then linked with the known object(s) at 212 to generate and obtain automatically labeled sensor data for each known object at 215. The automatically labeled sensor data for a known object associates at least a portion of the sensor data (from 204) with the known spatial characteristics of the known object. In the case in which the LIDAR system 128 provides the sensor data at 204, the sensor data can correspond to 3D LIDAR point cloud data. Each known object and its spatial characteristics can be linked with an appropriate portion of the 3D LIDAR point cloud data corresponding thereto. For example only, the known spatial characteristics may correspond to a bounding box for a known object and the sensor data corresponding to that bounding box may be automatically linked thereto. The labeled sensor data is stored for later use at 220. The labeled sensor data stored at 220 can be utilized in various ways. Two example uses of such data are described below.

In some aspects, at 213 the sensor data obtained from 204 is edited based on the known spatial characteristics of the known object in order to determine how the sensor data would be expected to change as the position, orientation, etc. of the known object changes. For example only, the sensor data from 204 can be edited to determine modified sensor data corresponding to different positions (closer to the sensor, farther from the sensor, etc.), a different size, and/or different orientations/headings of the known object. The modified sensor data includes one or more data sets (e.g., 3D LIDAR point cloud data), where each data set corresponds to the known object in a specific position/orientation. In such implementations, the automatically labeled sensor data generated or otherwise obtained at 215 for each known object is based on such modified sensor data. There are various ways of obtaining the above described modified sensor data, including but not limited to using a machine learning model such as a generative adversarial network to generate such data set(s) based on the sensor data obtained from 204.

At 224, the labeled sensor data can be utilized to train a machine learning model, such as a DNN, for object detection, avoidance, and other ADAS tasks. Essentially, the automatically labeled sensor data generated at 215 comprises training data that can be utilized for supervised learning of a machine learning model. It should be appreciated that such training data can be utilized for traditional machine learning model generation/training, validation, and testing, all of which will be referred to collectively and individually as “training” herein. Further, it should also be appreciated that the automatically labeled sensor data can be utilized separately or in combination with other training data, including manually annotated/labeled training data, for such training tasks.

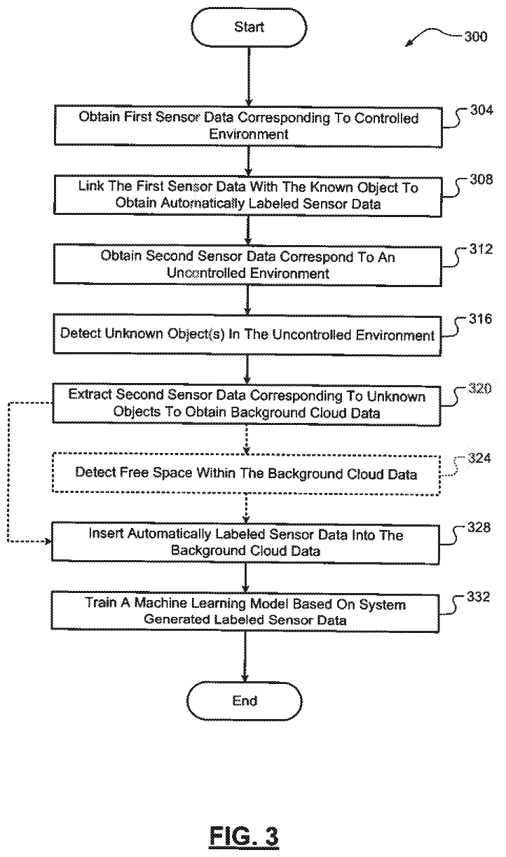

Another use for the labeled sensor data (at 228) is for generation of new labeled sensor data, which will be referred to herein as system generated labeled sensor data. As will be further described below, the automatically labeled sensor data for known objects can be inserted into later acquired sensor data from an uncontrolled environment in order to create such system generated labeled sensor data. With specific reference to FIG. 3, a flow diagram of a method 300 for generating such system generated labeled sensor data is illustrated. The method 300 can be performed by any computing device, including but not limited to the annotation system 132, the training system 136, the ADAS 124, and/or the controller 116 of the vehicle 100.

At 304, first sensor data corresponding to a controlled environment containing at least one known object is obtained. As mentioned above, the at least one known object has known spatial characteristics, including a location, orientation, etc. In some cases, the spatial characteristics correspond to a bounding box for the known object. It should be appreciated that there may be one or a plurality of known objects in the controlled environment, and sensor data corresponding to some or all of the known objects can be obtained at 304. In one example, the first sensor data corresponds to 3D LIDAR point cloud data obtained from the LIDAR system 128, although other types of sensor data may be utilized.

The obtained first sensor data is linked with the at least one known object at 308 to obtain automatically labeled sensor data for the at least one known object. The automatically labeled sensor data associates at least a portion of the first sensor data (obtained at 304) with the spatial characteristics of the known object(s). For example only, and continuing with the 3D LIDAR point cloud data example, the portion of the 3D LIDAR point cloud data that corresponds to the known object(s) will be linked thereto. In this manner, example 3D LIDAR point cloud data for known object(s) can be extracted from the first sensor data for storage and later use. Further, and as discussed above in conjunction with FIG. 2, the automatically labeled sensor data can correspond to the first sensor data with all known objects labeled therein, which can be used to train a machine learning model at 224.

At 312, second sensor data corresponding to an uncontrolled environment containing at least one unknown object is obtained. The second sensor data will be of the same type as the first sensor data, e.g., 3D LIDAR point cloud data. For example only, the uncontrolled environment is a public road on which the vehicle 100 is driven to collect the second sensor data. Other vehicles, traffic signs, and other objects will be present in the uncontrolled environment, and the second sensor data will contain sensor data corresponding to each of these unknown objects. A machine learning model is used to detect (316) the unknown object(s) in the uncontrolled environment based on the second sensor data. In one example, the machine leaning model is an object detection model trained to detect objects based on sensor data of the same type as the second sensor data.

In various implementations, the machine learning model generates a bounding box or the like for each detected object. The second sensor data can then be separated into sensor data corresponding to detected objects and sensor data that does not correspond to any detected object (“background data” or “background cloud data”). At 320, the portion(s) of the second sensor data corresponding to the unknown object(s) are extracted from the second sensor data to obtain the background cloud data. Background cloud data corresponds to the uncontrolled environment with the unknown objects removed. It should be appreciated, however, that extraction of the portion(s) of the second sensor data corresponding to the unknown object(s) may result in incomplete data of the uncontrolled environment.

Optionally, at 324 free space within the background cloud data is detected, e.g., through the use of a machine learning model such as a DNN. Free space corresponds to one or more locations in which objects can be present in the uncontrolled environment. For example only, free space may correspond to an open lane in a roadway, a sidewalk in which a pedestrian or bicycle may be present, or an intersection or other adjacent roadway. Free space may exclude location(s) in which objects should or could not be present, e.g., for an automobile, the open air above the ground, a side of a building, or a vertical surface of a bridge or overpass. The detection of free space permits for the generation of “real world” data in that objects will not be inserted into absurd or impractical/impossible locations/orientation (a car driving on the side of a bridge or building).

The automatically labeled sensor data for at least one known object (from 308) is inserted into the background cloud data at 328 to obtain simulated labeled data, which will be referred to as system generated labeled sensor data. In this manner, the system generated labeled sensor data will correspond to the uncontrolled environment with the unknown object(s) that were detected at 316 removed and at least one known object from the controlled environment inserted therein. In the examples in which free space is detected at 324, the automatically labeled sensor data is inserted into the detected free space of the background cloud data. Thus, the system generated labeled sensor data should correspond to data that is substantively similar to (or the same as) manually annotated labeled training data from the uncontrolled environment if the known object(s) were actually present in the free space thereof, without requiring the manual annotation by a human. Finally, at 332 the system generated labeled sensor data is used to train a machine learning model for the ADAS 124, e.g., the machine learning model that was used to detect unknown objects at 316. The method then ends of returns to 304.

The automatic annotation and generation process described above provides a simple and cost effective way to produce a large quantity of “simulated” labeled training data for uncontrolled environments. As mentioned above, such system generated labeled sensor data may be particularly useful for generating useful training data, e.g., data corresponding to corner cases.

It should be appreciated that the term “controller” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The controller could also include a memory as described above for storing sensor data and the like. The one or more processors could be either a single processor or two or more processors operating in a parallel or distributed architecture. The term “computing device” as used (or computing devices) refers to any suitable computing device or group of multiple computing devices that include(s) one or more processors and a non-transitory memory having instructions stored thereon and is/are configured to perform at least a portion of the techniques of the present disclosure.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A computer-implemented method of training a machine learning model, comprising:
obtaining, at a computing device having one or more processors, first sensor data corresponding to a controlled environment containing at least one known object, the at least one known object having known spatial characteristics;
linking, at the computing device, the first sensor data with the at least one known object to obtain automatically labeled sensor data for the at least one known object, the automatically labeled sensor data associating at least a portion of the first sensor data with the spatial characteristics of the at least one known object;
obtaining, at the computing device, second sensor data corresponding to an uncontrolled environment containing at least one unknown object;
detecting, at the computing device, the at least one unknown object in the uncontrolled environment based on the second sensor data by utilizing a machine learning model that is trained to detect objects based on sensor data;
extracting, at the computing device, a portion of the second sensor data corresponding to the at least one unknown object from the second sensor data to obtain background cloud data;
inserting, at the computing device, the automatically labeled sensor data into the background cloud data to obtain system generated labeled sensor data, the system generated labeled sensor data corresponding to the uncontrolled environment with the at least one unknown object removed and at least one known object from the controlled environment inserted; and
training, at the computing device, the machine learning model based on the system generated labeled sensor data.

2. The computer-implemented method of claim 1, wherein the first sensor data corresponds to data obtained from a light detection and ranging (LIDAR) system.

3. The computer-implemented method of claim 2, wherein the known spatial characteristics of the at least one known object are obtained from additional sensors.

4. The computer-implemented method of claim 1, further comprising detecting, at the computing device, free space within the background cloud data, wherein the free space corresponds to one or more locations in which the at least one known object can be present in the uncontrolled environment.

5. The computer-implemented method of claim 4, wherein a deep neural network (DNN) is utilized to detect the free space.

6. The computer-implemented method of claim 4, wherein the at least one known object from the controlled environment is inserted in the detected free space.

7. The computer-implemented method of claim 1, further comprising validating, at the computing device, the machine learning model based on the automatically labeled sensor data.

8. The computer-implemented method of claim 1, wherein training the machine model is further based on the automatically labeled sensor data.

9. The computer-implemented method of claim 1, wherein linking the first sensor data with the at least one known object to obtain automatically labeled sensor data for the at least one known object comprises:
editing the first sensor data to determine modified first sensor data corresponding to a change in at least one of a position, orientation, and size of the known object,
wherein the automatically labeled sensor data for the at least one known object is based on the modified first sensor data.

10. A computing device, comprising:
one or more processors; and
a non-transitory computer-readable storage medium having a plurality of instructions stored thereon, which, when executed by the one or more processors, cause the one or more processors to perform operations comprising:
obtaining first sensor data corresponding to a controlled environment containing at least one known object, the at least one known object having known spatial characteristics;
linking the first sensor data with the at least one known object to obtain automatically labeled sensor data for the at least one known object, the automatically labeled sensor data associating at least a portion of the first sensor data with the spatial characteristics of the at least one known object;
obtaining second sensor data corresponding to an uncontrolled environment containing at least one unknown object;
detecting the at least one unknown object in the uncontrolled environment based on the second sensor data by utilizing a machine learning model that is trained to detect objects based on sensor data;
extracting a portion of the second sensor data corresponding to the at least one unknown object from the second sensor data to obtain background cloud data;
inserting the automatically labeled sensor data into the background cloud data to obtain system generated labeled sensor data, the system generated labeled sensor data corresponding to the uncontrolled environment with the at least one unknown object removed and at least one known object from the controlled environment inserted; and
training the machine learning model based on the system generated labeled sensor data.

11. The computing device of claim 10, wherein the first sensor data corresponds to data obtained from a light detection and ranging (LIDAR) system.

12. The computing device of claim 11, wherein the known spatial characteristics of the at least one known object are obtained from additional sensors.

13. The computer-implemented method of claim 10, wherein the operations further comprise detecting free space within the background cloud data, wherein the free space corresponds to one or more locations in which the at least one known object can be present in the uncontrolled environment.

14. The computing device of claim 13, wherein a deep neural network (INN) is utilized to detect the free space.

15. The computing device of claim 13, wherein the at least one known object from the controlled environment is inserted in the detected free space.

16. The computing device of claim 10, wherein the operations further comprise validating the machine learning model based on the automatically labeled sensor data.

17. The computing device of claim 10, wherein training the machine model is further based on the automatically labeled sensor data.

18. The computing device of claim 10, wherein linking the first sensor data with the at least one known object to obtain automatically labeled sensor data for the at least one known object comprises:
editing the first sensor data to determine modified first sensor data corresponding to a change in at least one of a position, orientation, and size of the known object,
wherein the automatically labeled sensor data for the at least one known object is based on the modified first sensor data.
